(19) United States
(12) Patent Application Publication
(10) Pub. No.: US 2007/0045351 A1
(43) Pub. Date: Mar. 1, 2007

(54) Liquid feed pump, filter housing, valve and spray nozzle and spray apparatus incorporating the same

(75) Inventors: Yoshiyuki Seike, Owariasahi-shi (JP); Shigeru Taniguchi, Owariasahi-shi (JP); Masanori Kojima, Owariasahi-shi (JP); Kentaro Otani, Owariasahi-shi (JP); Keiji Miyachi, Owariasahi-shi (JP); Masahiko Amari, Owariasahi-shi (JP)

Correspondence Address: ROBERTS, MLOTKOWSKI & HOBBES, P. O. BOX 10064, MCLEAN, VA, 22102-8064, US

(73) Assignee: Asahi Sunac Corporation, Owariasahi-shi (JP)

(21) Appl. No.: 11/328,287

(22) Filed: Jan. 10, 2006

(30) Foreign Application Priority Data
Aug. 25, 2005 (JP) 2005-244465

(51) Int. Cl. B67D 5/40; B05C 5/00

(52) U.S. Cl. 222/384; 118/300; 222/372

(57) ABSTRACT

To provide a liquid feed pump, a filter housing, a valve and a spray nozzle and a spray apparatus incorporating these components that can suppress contamination of the liquid being fed. A liquid feed pump 10 includes: a cylinder 12 having a substantially cylindrical shape; and a piston 14 fitted into the cylinder. The liquid feed pressure of the liquid feed pump 10 is equal to or higher than 1 MPa and equal to or lower than 50 MPa, and substantially the whole surface of a liquid contacting part of the liquid feed pump is made of a resin material or a ceramic material.

### BACKGROUND OF THE INVENTION

Field of the Invention

The present invention relates to a liquid feed pump, a filter housing, a valve and a spray nozzle and a spray apparatus incorporating the same. In particular, it relates to a liquid feed pump that can suppress contamination of liquid to be fed, a filter housing, a valve and a spray nozzle and a spray apparatus incorporating the same.

Description of the Related Art

In fabrication of a semiconductor integrated circuit or the like, it is required to suppress contamination by contaminations or metal ions to low level, so that it has been common practice to use ultrapure water.

Besides, the chemical mechanical polishing (CMP) has come into common use for planarization of an interlayer dielectric or the like, and ultrapure water is desirably used for making slurries used in CMP and for conditioning polishing pads used for CMP (see Japanese Patent No. 2997804, for example).

A conditioner apparatus disclosed in Japanese Patent No. 2997804 uses high-pressure spray. The conditioner apparatus can remove polishing residue accumulated on and in a polishing pad and is significantly effective for preventing scratches. Such high-pressure spray can be produced by use of a pump capable of producing a high pressure (equal to or higher than 15 MPa and equal to or lower than 30 MPa, for example).

It is also desirable that the conditioner apparatus uses ultrapure water to suppress contamination by contaminations or metal ions during CMP to low level.

### SUMMARY OF THE INVENTION

A liquid contacting part of such a pump capable of producing high pressure (a cylinder part, for example) is made of stainless steel (SUS316L, for example) or stainless steel electropolished, from the viewpoint of pressure resistance and rust prevention. However, these materials have the following problems.

a) Stainless steel may cause contamination of the liquid used by a contamination or a metal ion and cannot be used in such a case.

b) Depending on the liquid used, stainless steel may be corroded (rusted) and thus cannot be used. Even if pure water is used, stainless steel may be corroded (rusted) because of crevice corrosion or the like.

c) When the liquid reaches a high temperature during use, the liquid contacting part is made of metal (such as stainless steel) conducts heat to an accessible part (a tip of a nozzle, for example), and a user who touches the part may get burnt.

d) When a packing (a V-packing, for example) is used at a sliding part of the pump, contamination by a contamination or a metal ion may be caused by particles derived from wearing of the packing.

In addition, contamination by a metal (such as from an Al layer and a Cu layer) or a material eluted from the apparatus may occur.

Thus, there has been a demand for a liquid feed pump and other components (including a filter housing, a valve and a spray nozzle) and a spray apparatus incorporating these components that solve the problems described above. However, ones that can be practically used have not been provided.

The present invention has been devised in view of such circumstances, and an object of the present invention is to provide a liquid feed pump, a filter housing, a valve and a spray nozzle and a spray apparatus incorporating these components that can suppress contamination of the liquid being fed.

In order to attain the object, the present invention provides a liquid feed pump comprising: a cylinder having a substantially cylindrical shape; and a piston fitted into the cylinder, in which the liquid feed pressure is equal to or higher than 1 MPa and equal to or lower than 50 MPa, and substantially the whole surface of a liquid contacting part of the liquid feed pump is made of a resin material or a ceramic material.

According to the present invention, if the pump is one that can produce high pressure, contamination of the liquid being fed can be suppressed, because substantially the whole surface of the liquid contacting part is made of a resin material or a ceramic material.

According to the present invention, it is preferred that the clearance between the cylinder and the piston falls within a range of 1 to 20 μm over substantially the whole surface of the cylinder. If no packing material is used to maintain a clearance of 1 to 20 μm over substantially the whole surface of the cylinder in this way, rather than using a packing material such as an O-ring to eliminate the clearance (gap) at the sealed part, substantially the whole surface of the liquid contacting part is made of a resin material or a ceramic material, and thus, contamination of the liquid being fed can be suppressed. In addition, no particles are produced by wearing of the packing material. More preferably, the clearance falls within a range of 1 to 2.5 μm over substantially the whole surface of the cylinder.

Furthermore, according to the present invention, it is preferred that the amount of liquid leakage from the clearance between the cylinder and the piston is equal to or less than 2 L/minute. If no packing material is used to maintain a constant clearance between the cylinder and the piston over substantially the whole surface of the cylinder, and the amount of liquid leakage equal to or less than 2 L/minute is achieved without any packing material, contamination of the liquid being fed can be suppressed without causing any practical disadvantage.

In addition, the present invention provides a filter housing that houses a filter element and is used under a liquid pressure equal to or higher than 1 MPa and equal to or lower than 50 MPa, in which substantially the whole surface of a liquid contacting part of the filter housing is made of a resin material or a ceramic material.

According to the present invention, even if the filter housing is one that is used under high pressure, contamination of the liquid being fed can be suppressed, because substantially the whole surface of the liquid contacting part is made of a resin material or a ceramic material.

In addition, the present invention provides a spray nozzle that is used under a liquid pressure equal to or higher than 1 MPa and equal to or lower than 50 MPa, in which substantially the whole surface of a liquid contacting part of the spray nozzle is made of a resin material or a ceramic material.

According to the present invention, even if the spray nozzle is one that is used under high pressure, contamination of the liquid being fed can be suppressed, because substantially the whole surface of the liquid contacting part is made of a resin material or a ceramic material.

In addition, the present invention provides a valve that is used under a liquid pressure equal to or higher than 1 MPa and equal to or lower than 50 MPa, in which substantially the whole surface of a liquid contacting part of the valve is made of a resin material or a ceramic material.

According to the present invention, even if the valve is one that is used under high pressure, contamination of the liquid being fed can be suppressed, because substantially the whole surface of the liquid contacting part is made of a resin material or a ceramic material.

In addition, the present invention provides a spray apparatus comprising: a liquid feed pump; a filter unit including a filter housing; a valve; a spray nozzle; and a piping member that interconnects the liquid feed pump, the filter unit, the valve and the spray nozzle, in which the liquid feed pressure is equal to or higher than 1 MPa and equal to or lower than 50 MPa, and substantially the whole surface of a liquid contacting part of the spray apparatus is made of a resin material or a ceramic material.

According to the present invention, even if the spray apparatus is one that is used under high pressure, contamination of the liquid being fed can be suppressed, because substantially the whole surface of the liquid contacting part is made of a resin material or a ceramic material.

According to the present invention, it is preferred that the resin material is polyetheretherketone. Polyetheretherketone (registered trademark “PEEK”) is less susceptible to contamination, and thus, contamination of the liquid being fed can be suppressed more effectively.

In addition, according to the present invention, it is preferred that the ceramic material is zirconia. Zirconia is less susceptible to contamination, and thus, contamination of the liquid being fed can be suppressed more effectively.

In addition, according to the present invention, it is preferred that the amount of contamination of the liquid being fed by a metal ion is lower than 10 ng/cm³ in terms of ICP mass spectrometry value. If the amount of contamination is lower than a predetermined value in this way, the possibility of contamination is reduced, and thus, contamination of the liquid being fed can be suppressed more effectively.

According to the present invention, contamination of the liquid being fed can be suppressed.

### BRIEF DESCRIPTION OF THE DRAWINGS

FIG. 1A shows an arrangement of a liquid feed pump according to the present invention;

FIG. 1B shows an arrangement of a liquid feed pump according to the present invention;

FIG. 2 is a cross-sectional view of a filter housing according to the present invention;

FIG. 3 is a cross-sectional view of a valve according to the present invention;

FIG. 4 is a cross-sectional view of a spray nozzle according to the present invention;

FIG. 5 is a bottom view of the spray nozzle according to the present invention;

FIG. 6 shows an arrangement of a spray apparatus according to the present invention;

FIG. 7 is a table showing results of an example;

FIG. 8 is a graph showing results of the example;

FIG. 9 is a graph showing results of the example; and

FIG. 10 is a table showing result of the example.

### DETAILED DESCRIPTION OF THE PREFERRED EMBODIMENTS

In the following, with reference to the accompanying drawings, a liquid feed pump, a filter housing, a valve and a spray nozzle and a spray apparatus incorporating the same according to preferred embodiments of the present invention will be described in detail.

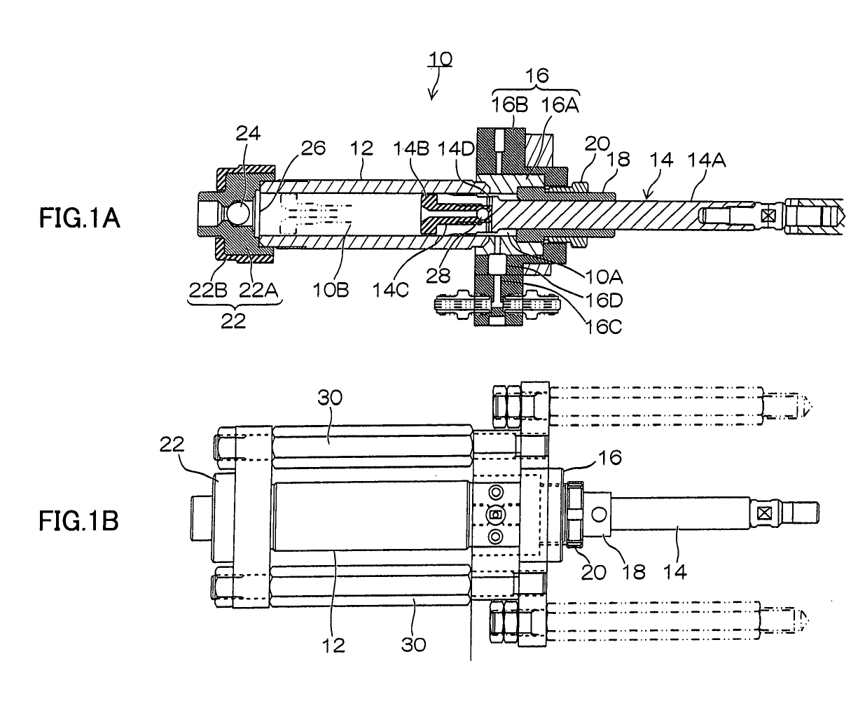

First, a liquid feed pump according to the present invention (a first embodiment of the present invention) will be described. FIGS. 1A and 1B show arrangements of a liquid feed pump 10 of plunger type according to the present invention. FIG. 1A is a cross-sectional view of the liquid feed pump 10, and FIG. 1B is a plan view of the same. The liquid feed pump 10 comprises a cylinder 12 having a substantially cylindrical shape and a piston 14 fitted into the cylinder 12, and achieves a liquid feed pressure equal to or higher than 1 MPa and equal to or lower than 50 MPa. Substantially the whole surface of the liquid contacting part of the liquid feed pump is made of a resin material or a ceramic material.

The cylinder 12 is made of zirconia (ZrO₂). The piston 14 is fitted into the cylinder 12 and can slide in a horizontal direction. The clearance between the cylinder 12 (or the inner diameter thereof) and the tip-end part of the piston 14 (or the outer diameter thereof) falls within a range of 1 to 20 μm over substantially the whole inner surface of the cylinder 12 and the whole outer surface of the piston. More preferably, the clearance falls within a range of 1 to 2.5 μm.

Provided that the inner diameter of the cylinder 12 is 28.5 mm, the clearance ranging from 1 to 2.5 μm is equivalent to 35×10⁻⁶ to 88×10⁻⁶% of the inner diameter.

A pump housing 16 is fixed to the right end of the cylinder 12, and the piston 14, the cylinder 12 and the pump housing 16 constitute a liquid compression chamber 10A. The pump housing 16 comprises a pump housing main unit 16A that is made of polyetheretherketone and a pump housing frame unit 16B that is made of stainless steel (SUS304) and surrounds the pump housing main unit 16A. The pump housing 16 has a through hole 16C, which permits liquid in the liquid compression chamber 10A to flow to the outside.

Sealing between the piston 14 and the pump housing 16 is achieved by a packing retainer 18 that is made of polyetheretherketone and interposed therebetween and a packing gland 20 that is made of stainless steel (SUS316) and surrounds the packing retainer 18. The packing gland 20 has an external thread formed on the outer surface, which engages with an internal thread formed on the inner surface of the right-hand part of the pump housing main unit 16A, thereby fixing the packing gland 20 to the pump housing main unit 16A.

The clearance between the piston 14 and the packing retainer 18 also falls within a range of 1 to 20 μm over substantially the whole inner surface of the packing retainer 18. More preferably, the clearance falls within a range of 1 to 2.5 μm.

Provided that the inner diameter of the packing retainer 18 is 40 mm, the clearance ranging from 1 to 2.5 μm is equivalent to 35×10⁻⁶ to 88×10⁻⁶% of the inner diameter.

A foot valve 22 is fixed to the left end of the cylinder 12, and the piston 14, the cylinder 12 and the foot valve 22 constitute a liquid compression chamber 10B. Sealing between the cylinder 12 and the foot valve 22 is achieved by a foot valve main unit 22A made of polyetheretherketone. The foot valve main unit 22A is supported by a foot valve frame unit 22B that is made of stainless steel (SUS304) and surrounds the foot valve main unit 22A, thereby maintaining the strength of the foot valve 22.

The foot valve main unit 22A houses a valve ball 24 made of polyetheretherketone, which permits liquid to flow into the cylinder 12 (liquid compression chamber 10B) while preventing liquid in the cylinder 12 (liquid compression chamber 10B) to flow out thereof (flow backward). In addition, a stopper 26 made of polyetheretherketone is disposed at the right end of the foot valve main unit 22A to prevent the valve ball 24 from dropping off the foot valve main unit 22A.

The piston 14 comprises a piston rod 14A that is, although not shown, composed of an inner rod made of stainless steel (SUS304) and an outer sleeve made of zirconia surrounding the inner rod and a check valve 14B screwed into the left-end part of the piston rod 14A. Specifically, the piston rod 14A has a countersunk bore 14C formed in the left-end part thereof, and the check valve 14B is screwed into an internal thread formed in the countersunk bore 14C.

In addition, a through hole 14D extending perpendicularly to the axis of the piston rod 14A is formed in the vicinity of the bottom of the countersunk bore 14C and permits communication between the liquid compression chambers 10A and 10B.

Furthermore, a valve ball 28 made of polyetheretherketone is disposed in the vicinity of the bottom of the countersunk bore 14C and permits liquid to flow from the liquid compression chamber 10B to the liquid compression chamber 10A while preventing liquid to flow (backward) from the liquid compression chamber 10A to the liquid compression chamber 10B. In addition, the check valve 14B can prevent the valve ball 28 from dropping off the countersunk bore 14C.

The right-end part of the piston rod 14A is configured to be connected to a reciprocating drive unit (not shown). Driven by the reciprocating drive mechanism, the tip-end part (left-end part) of the piston 14 can reciprocate between a position indicated by a solid line in FIG. 1A and a position indicated by an imaginary line (a long dashed double-short dashed line) in FIG. 1A.

According to another configuration of the liquid feed pump 10, as shown in FIG. 1B, bolt members 30, 30 extending in parallel with the cylinder 12 are disposed on the opposite sides of the cylinder 12, thereby bringing the pump housing 16 and the foot valve 22 into intimate contact with the respective opposing ends of the cylinder 12.

Now, an operation of the liquid feed pump 10 will be described.

First, when the tip-end part (left-end part) of the piston 14 starts moving from the position indicated by the imaginary line (long dashed double-short dashed line) in FIG. 1A to the position indicated by the solid line in FIG. 1A, the liquid compression chamber 10B is decompressed, and liquid flows from the outside into the liquid feed pump 10 (specifically, the liquid compression chamber 10B) via the foot valve 22. At this time, the valve ball 28 serves as a check valve, so that no liquid flows between the liquid compression chamber 10A and the liquid compression chamber 10B.

At the same time, the liquid in the liquid compression chamber 10A is compressed and flows from the liquid feed pump 10 (specifically, the liquid compression chamber 10A) to the outside through the through hole 16C.

Then, when the tip-end part (left-end part) of the piston 14 starts moving from the position indicated by the solid line in FIG. 1A to the position indicated by the imaginary line (long dashed double-short dashed line) in FIG. 1A, the liquid compression chamber 10B is compressed, and the liquid in the liquid compression chamber 10B flows into the liquid compression chamber 10A via the check valve 14B. In addition, part of the liquid flowing into the liquid compression chamber 10A flows out of the liquid feed pump 10 through the through hole 16C.

At this time, the valve ball 24 serves as a check valve and prevents any liquid from flowing from the liquid feed pump 10 (specifically, the liquid compression chamber 10B) to the outside.

If the liquid feed pump 10 is constructed as described above, even if the pump is one capable of producing a high pressure (specifically a liquid feed pressure equal to or higher than 1 MPa and equal to or lower than 50 MPa), contamination of the liquid being fed can be suppressed, because substantially the whole surface of the liquid contacting part is made of a resin material (polyetheretherketone) or a ceramic material (zirconia (ZrO₂)). Although the pump housing frame unit 16B has the through hole 16C as described above, an insert 16D made of polyetheretherketone is fitted into the through hole 16C, so that no liquid comes into direct contact with the pump housing frame unit 16B.

In addition, this liquid feed pump 10 does not use any packing materials including an O-ring, and the clearance between the cylinder 12 and the piston 14 is set to fall within a range of 1 to 2.5 μm over substantially the whole surface of the cylinder 12. Thus, any particles derived from wearing of packing materials are not produced.

Furthermore, if the clearance between the cylinder 12 and the piston 14 falls within the range described above, the amount of liquid leakage through the clearance is 2 L/minute or less, which causes no practical problem.

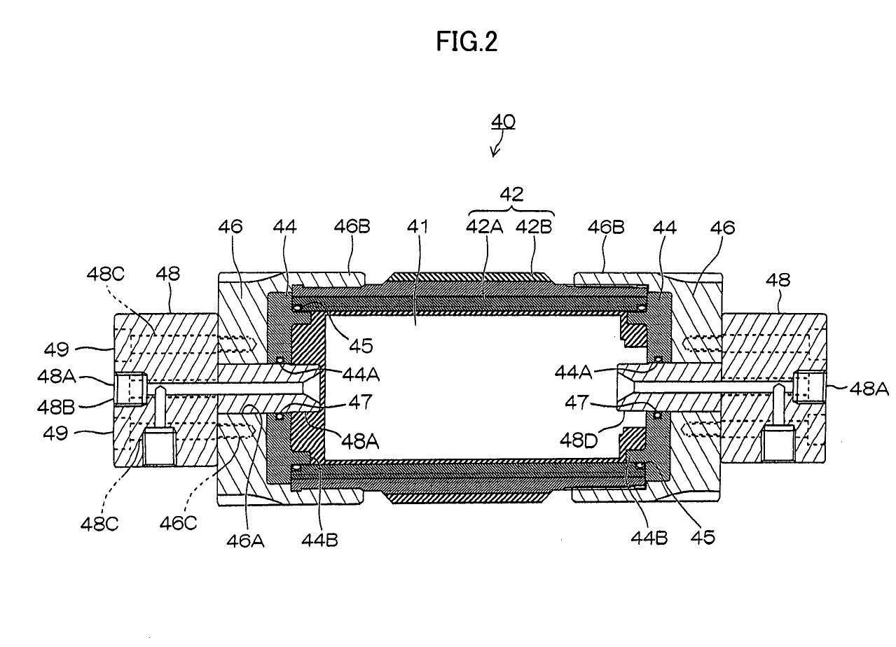

In the following, a filter housing according to the present invention (a second embodiment of the present invention) will be described. FIG. 2 is a cross-sectional view of a filter housing 40 according to the present invention. The filter housing 40 is used under a liquid pressure equal to or higher than 1 MPa and equal to or lower than 50 MPa and houses a filter element 41 therein, and substantially the whole surface of the liquid contacting part thereof is made of a resin material or a ceramic material.

The filter element 41 housed may be any element that is commercially available under the generic name of cartridge filter or the like. As the filter element 41, a filter element can be adopted which has a cylindrical shape and whose cartridge receives liquid from the periphery thereof through a filtering surface and discharges the liquid from the center of one end thereof (the right end thereof in the drawing). The filter housing 40 is a component that supports the filter element 41.

The filter housing 40 comprises a housing main unit 42, presser plates 44, 44, nuts 46, 46, end blocks 48, 48 and the like.

The housing main unit 42 is a cylindrical component and comprises an inner sleeve 42A made of polyetheretherketone and an outer sleeve 42B made of stainless steel (SUS316) surrounding the inner sleeve 42A. The inner sleeve 42A serves to suppress contamination of the liquid being fed, and the outer sleeve 42B serves to provide resistance to the liquid pressure (a liquid pressure of 50 MPa or higher, for example).

The presser plate 44 is a disk-shaped component made of polyetheretherketone. The presser plate 44 has a through hole 44A, into which a tip-end part 48A of the end block 48 is fitted, formed at the center thereof and a cylindrical protrusion 44B, which is fitted onto the inner surface of the housing main unit 42, formed on one side thereof.

The nut 46 is a cup-shaped component made of stainless steel (SUS316). The nut 46 has a through hole 46A, into which the tip-end part 48A of the end block 48 is fitted, formed at the center thereof and a cylindrical protrusion 46B formed on one side thereof. The protrusion 46B has an internal thread on the inner surface thereof, and the internal thread is configured to engage with an external thread formed on the outer surface of the housing main unit 42.

In addition, in the other side of the nut 46, there are formed a plurality of screw holes 46C, into which cap screws 49 for fixing the end block 48 are to be screwed.

The end block 48 is a cylindrical component made of polyetheretherketone and has a through hole 48A, which serves as an inlet or outlet for liquid to flow into or out of the filter housing 40. The end block 48 has the tip-end part 48D formed on one side thereof, and the tip-end part 48D has a size (outer diameter) that allows fitting into the through hole 46A of the nut 46 and the through hole 44A of the presser plate 44.

The through hole 48A has an internal thread 48B formed at one end thereof, and thus, a pipe member can be screwed into the through hole 48A. In addition, the end block 48 has a plurality of bolt holes 48C, which are through holes, formed along the circumference thereof, and bolt members (the cap screws 49) can be inserted into the bolt holes 48C. Therefore, the end block 48 can be fixed to the nut 46 by inserting the cap screws 49 into the bolt holes 48C and the screw holes 46C in the nut 46.

Now, an operation of the filter housing 40 will be described. Liquid flows into the housing main unit 42 through the through hole 48A of the left-hand end block 48 and is filtered when flowing from the periphery of the filter element 41 into the filter element 41 (cartridge) through the filtering surface. The filtered liquid flows to the outside from the center of the right end of the filter element 41 through the through hole 48A of the right-hand end block 48.

If the filter housing 40 is constructed as described above, even if the filter housing is one that can be used under high pressure (a liquid feed pressure equal to or higher than 1 MPa and equal to or lower than 50 MPa), contamination of the liquid being fed can be suppressed, because substantially the whole surface of the liquid contacting part is made of a resin material (polyetheretherketone).

In addition, O-rings 45 and 47 serving as packing materials are disposed between the tip-end parts of the housing main unit 42 and the presser plates 44 and between the through holes 44A of the presser plates 44 and the tip-end parts 48D of the end block 48, respectively. The O-rings 45 and 47 are intended to prevent liquid leakage and are not in direct contact with the liquid, so that the O-rings 45 and 47 do not pollute the liquid being fed.

While substantially the whole surface of the liquid contacting part of the filter housing 40 is made of a resin material (polyetheretherketone) in the embodiment described above, it can be made of a ceramic material (zirconia (ZrO₂)), rather than a resin material, to provide the same advantage.

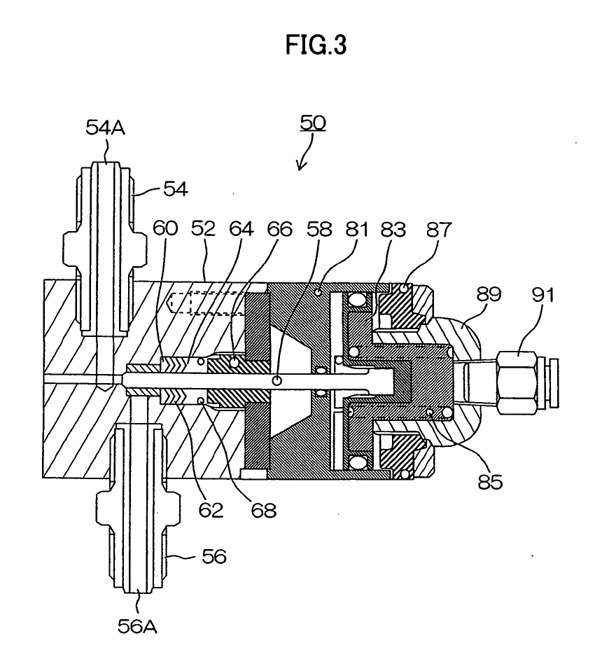

In the following, a valve according to the present invention (a third embodiment of the present invention) will be described. FIG. 3 is a cross-sectional view of a valve 50 according to the present invention. The valve 50 is used under a liquid pressure equal to or higher than 1 MPa and equal to or lower than 50 MPa, and substantially the whole surface of the liquid contacting part thereof is made of a resin material or a ceramic material.

The valve 50 comprises a valve main unit 52 (body), joints 54, 56 fixed (screwed) to the valve main unit 52, a needle 58 a cylinder 81, an end cap 89 and the like.

The joints 54 and 56 have through holes 54A and 56A, respectively. The through hole 54A of the joint 54 and the through hole 56A of the joint 56 can be in communication with each other via the interior of the valve main unit 52.

The needle 58 is fitted into the valve main unit 52. As can be seen from FIG. 3, the communication between the through hole 54A of the joint 54 and the through hole 56A of the joint 56 is opened and shut off by a horizontal movement of the needle 58.

The horizontal movement of the needle 58 is controlled by use of a spring 85, compressed air supplied from a quick fitting 91 and compressed air supplied from a quick fitting arranged in a position perpendicular to the sheet of FIG. 3 (not shown).

Sealing of the needle 58 in the valve main unit 52 is achieved by a packing washer 60 made of polyetheretherketone, a V-packing 62 made of polyethylene (PE) disposed at the back of the packing washer 60 (shown at the right side of the packing washer 60 in the drawing), a packing washer 64 made of polyetheretherketone disposed at the back of the V-packing 62 (shown at the right side of the V-packing 62 in the drawing), and a packing adjuster 66 made of polyetheretherketone disposed at the back of the packing washer 64 (shown at the right side of the packing washer 64 in the drawing).

If the valve 50 is constructed as described above, even if the valve is one that is used under a high pressure (a liquid feed pressure equal to or higher than 1 MPa and equal to or lower than 50 MPa), contamination of the liquid being fed can be suppressed, because substantially the whole surface of the liquid contacting part is made of a resin material (polyetheretherketone).

While an O-ring 68 is used as a packing material between the valve main unit 52 and the packing washer 64, the O-ring 68 is intended to prevent liquid leakage and is not in direct contact with the liquid, so that the O-ring 68 does not pollute the liquid being fed.

In addition to the components described above, the valve 50 has components including a cylinder 81, a piston 83, an end plate 87 and an end cap 89. However, these components are the same as those used in known valves and, therefore, are not described in particular herein. Similarly, the operation of the valve 50 is substantially the same as those of known valves and, therefore, is not described in particular herein.

In the following, a spray nozzle according to the present invention (a fourth embodiment of the present invention) will be described. The spray nozzle is used under a liquid pressure equal to or higher than 1 MPa and equal to or lower than 50 MPa, and substantially the whole surface of the liquid contacting part is made of a resin material or a ceramic material.

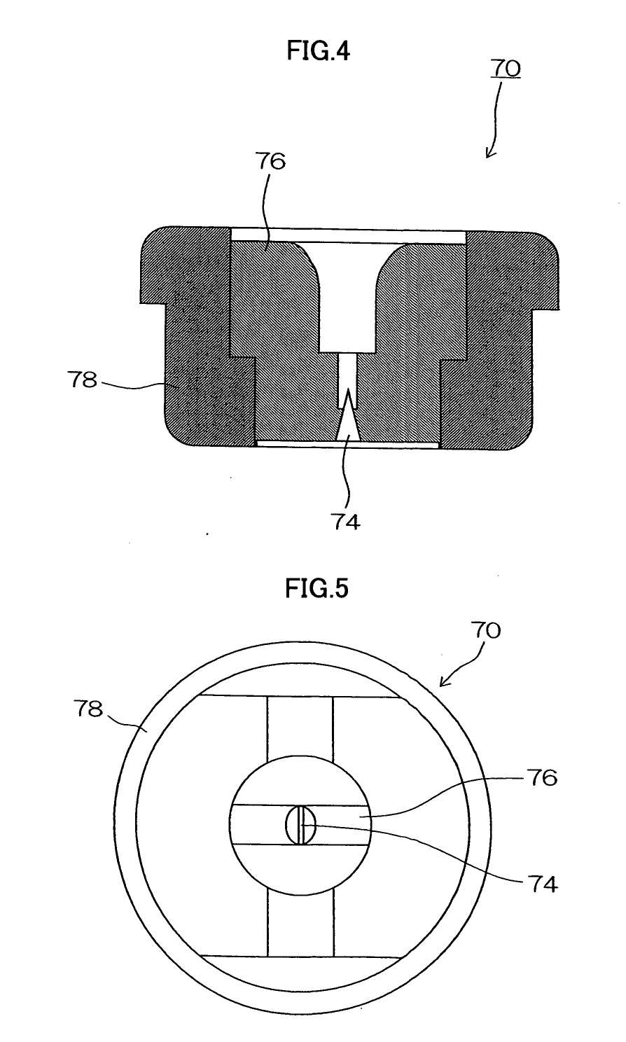

FIGS. 4 and 5 show an arrangement of a nozzle (a spray nozzle) 70. The nozzle 70 comprises a nozzle tip 76 having an outlet 74 and a nozzle case 78 into which the nozzle tip 76 is fitted. The nozzle tip 76 is made of zirconia (ZrO₂), and the nozzle case 78 is made of polyetheretherketone.

As shown in FIG. 5, the outlet 74 has a slit-like cross section at the top, which expands to form an elliptic cross section having a major axis of 500 μm and a minor axis of 200 μm as the outlet 74 extends frontward (downward in FIG. 4).

According to this embodiment, even if the spray nozzle is one that is used under high pressure, contamination of the liquid being fed can be suppressed, because substantially the whole surface of the liquid contacting part is made of a resin material or a ceramic material.

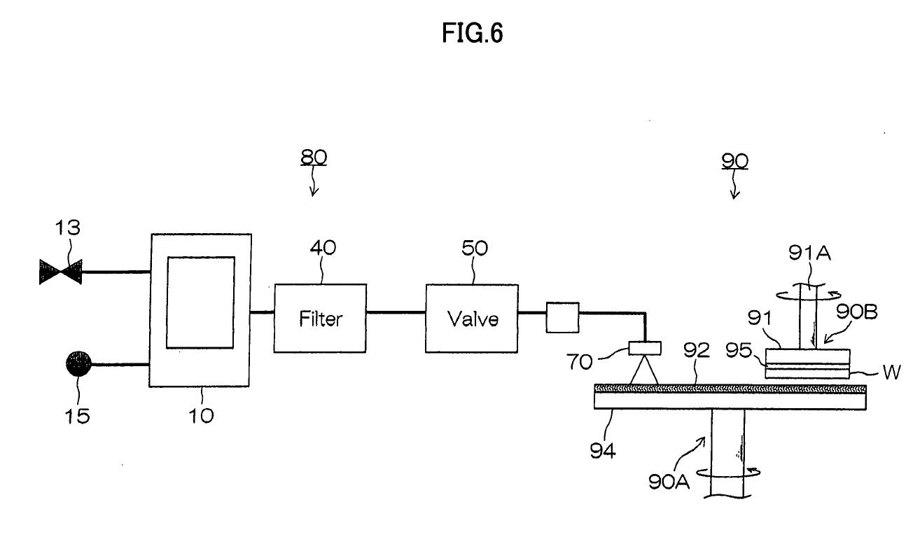

In the following, a spray apparatus according to the present invention (a fifth embodiment of the present invention) will be described. FIG. 6 shows an arrangement of a spray apparatus 80. The spray apparatus 80 is used for conditioning a polishing pad 92 used in a polishing apparatus 90. First, the polishing apparatus 90 will be described.

The polishing apparatus 90 essentially comprises a polishing surface plate 94, a polishing apparatus main unit 90A that makes the polishing surface plate 94 rotate, a polisher head 90B that rotatably supports a wafer holding head 91 that holds a workpiece W, a slurry supplying device (not shown) that supplies a slurry (a suspension of an abrasive; a mechanochemical abrasive is commonly used) and the like.

The polishing surface plate 94 has a disk-like shape and rotates in one direction by being driven by a motor (not shown) connected to the bottom thereof. A polishing pad 92 is applied to the upper surface of the polishing surface plate 94, and the slurry is supplied onto the polishing pad 92.

The wafer holding head 91 is a disk-shaped component that holds the workpiece W on the bottom thereof, and a force for pressing the workpiece W against the polishing pad 92 applied by a pressing device (not shown) is transferred by a pressing shaft 91A connected to the center of the upper surface of the wafer holding head 91. As the polishing surface plate 94 rotates, the wafer holding head 91 rotates in the same direction as (together with) the polishing surface plate 94. In addition, a backing film 95 is interposed between the wafer holding head 91 and the workpiece W.

The polishing apparatus 90 polishes the workpiece W by pressing the workpiece W, such as a wafer, against the rotating polishing pad 92 with a predetermined pressure and supplying the abrasive slurry so that the slurry penetrates between the polishing pad 92 and the workpiece W.

With use, such a polishing pad 92 becomes clogged with polishing residues, such as a reaction product and abrasive grains, and thus needs to be dressed. According to a typical conditioning method, a pad dresser, which is a brush or a grindstone, is pressed against the polishing pad 92 to finely roughen the surface of the polishing pad 92. However, this method cannot remove polishing residues accumulated in a deep part of the polishing pad 92.

In addition, since the polishing pad 92 has to be scrubbed with a brush or grindstone, the polishing pad 92 may be disadvantageously damaged or polluted by scrap pieces of the brush or grindstone. Furthermore, the workpiece W (an electronic device or the like) may be scratched by a lump of abrasive, a particle dropping off the pad dresser or the like.

Thus, as an alternative to this conditioning method, the spray apparatus 80 shown in FIG. 6 is adopted. The spray apparatus 80 dresses the polishing pad 92 by spraying a cleaning liquid, such as pure water, from the conditioning nozzle 70 onto the polishing pad 92 placed on the surface plate 94 of the polishing apparatus 90. In the following, an arrangement of the spray apparatus 80 will be described.

Viewed from the upstream side, the spray apparatus 80 comprises the liquid feed pump 10, a filter unit including the filter housing 40, the valve 50, the nozzle 70 (the spray nozzle) and a piping member that interconnects these components. In addition, the liquid feed pump 10 is connected to a compressed air supplying device 13 for driving the pump and an ultrapure water supplying device 15 on the upstream side thereof.

The spray apparatus 80 is characterized in that the liquid feed pressure is equal to or higher than 1 MPa and equal to or lower than 50 MPa, and substantially the whole surface of the liquid contacting part is made of a resin material or a ceramic material. As a result, the cleaning liquid can be sprayed from the nozzle 70 at a high pressure. Preferably, the polishing pad 92 is dressed by spraying, as the cleaning liquid, droplets of ultrapure water having a diameter equal to or larger than 1 μm and equal to or smaller than 500 μm at a speed equal to or higher than 10 m/s and equal to or lower than 500 m/s from the nozzle 70 onto the polishing pad 92.

In addition, even if the spray apparatus 80 is used under a high pressure, contamination of the liquid being fed can be advantageously suppressed, because substantially the whole surface of the liquid contacting part is made of a resin material or a ceramic material.

While the liquid feed pump, the filter housing, the valve, the spray nozzle and the spray apparatus incorporating these components according to embodiments of the present invention have been described above, the present invention is not limited thereto, and various modifications are possible.

For example, according to the embodiments described above, the liquid feed pump 10 used is a plunger-type pump. However, the liquid feed pump 10 may be of other types. In addition, the filter housing 40 and the valve 50 are not limited to the arrangements shown in the drawings and can have various other arrangements.

In addition, while the piping member has not been described in detail above, the piping member may be one having a hose inner tube made of a fluorocarbon resin (such as PTFE) and a hose outer tube composed of a stainless steel wire braid or one made of polyetheretherketone.

### EXAMPLE

Contamination of materials used for the liquid contacting parts of the liquid feed pump, the filter housing, the valve, the spray nozzle and the spray apparatus incorporating these components by a metal ion was evaluated.

In the evaluation, five kinds of resin materials were used: polyetheretherketone (registered trademark “PEEK”); SUS316L stainless steel coated with fluorocarbon resin (registered trademark “Teflon”); polyimide resin (registered trademark “Vespel”, Type SP-1, manufactured by DuPont); polyimide resin (registered trademark “Vespel”, Type SP-2, containing 15% of graphite, manufactured by DuPont); and high density polyethylene resin.

Besides, four kinds of ceramic materials were used in the evaluation: zirconia (ZrO₂); silicon nitride (SiN); alumina (Al₂O₃); and silicon carbide (SiC). As a metal material for comparison, SUS316L stainless steel electropolished was used.

Each sample was placed in a vessel containing ultrapure water, ultrasonically cleaned with an ultrasonic cleaner for one hour, taken out of the vessel, and then cleaned (rinsed) with running ultrapure water. Then, the sample was placed in a vessel (made of PFA) containing 50 ml of ultrapure water, and the vessel was sealed. Then, the sample was immersed in the ultrapure water at a room temperature for seven days.

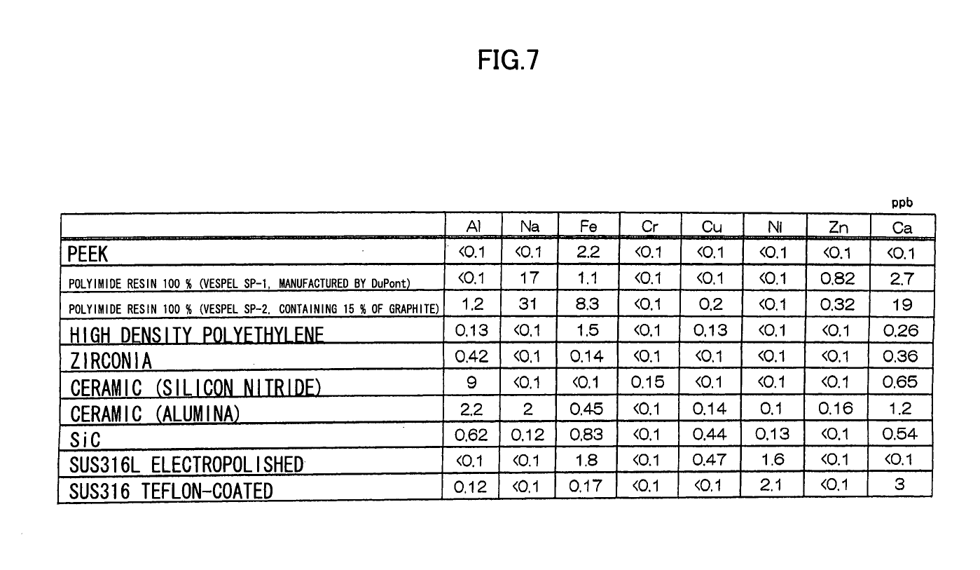

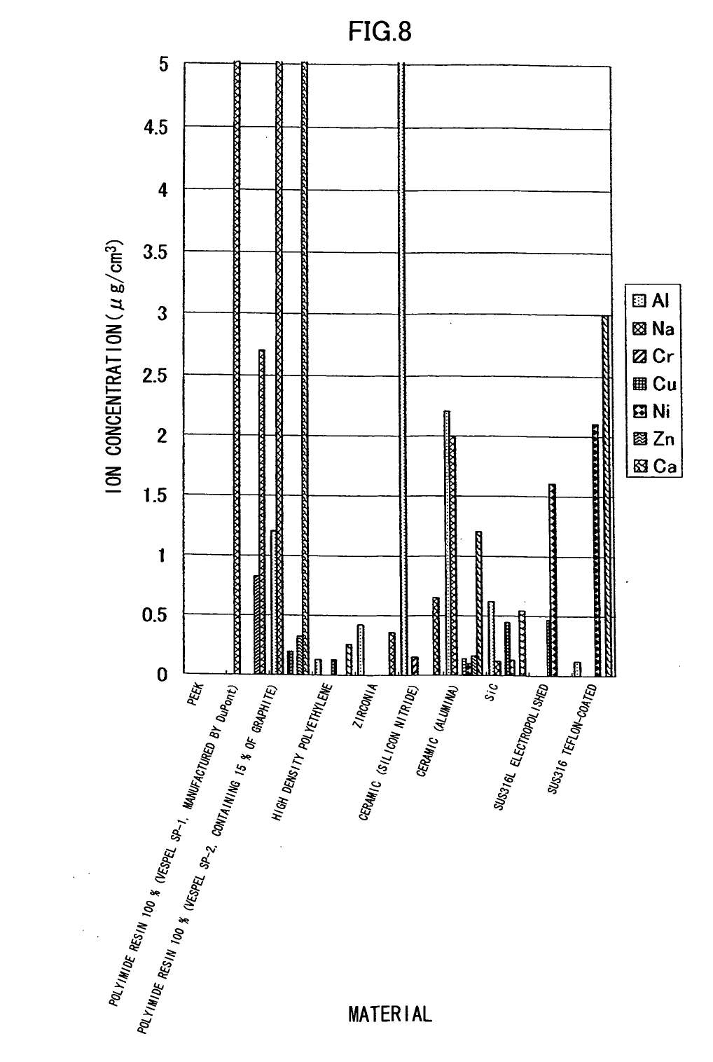

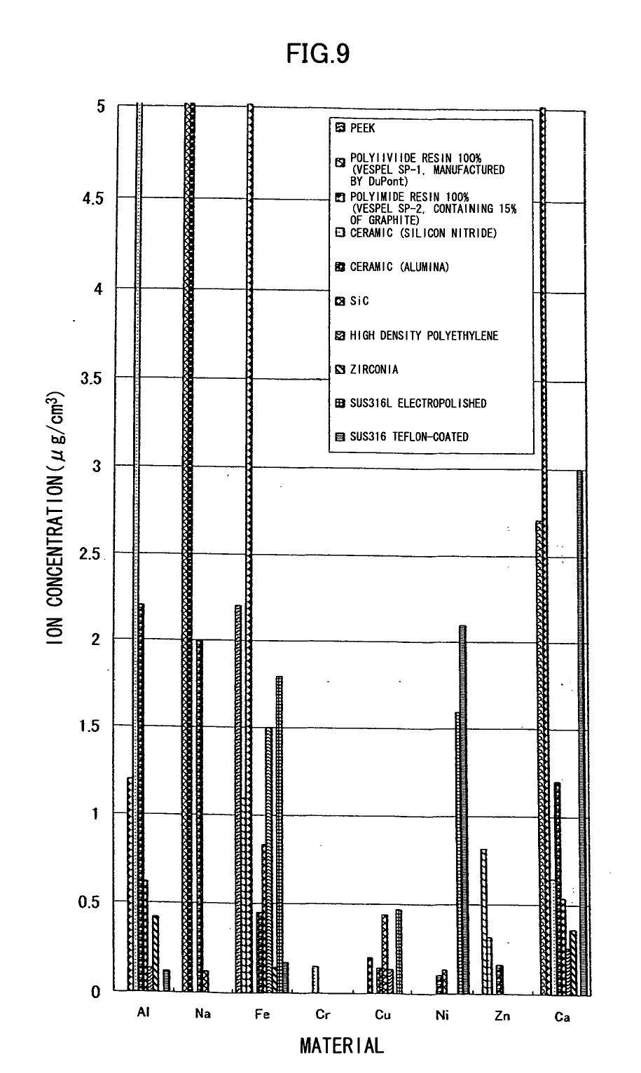

Then, the ultrapure water in the vessel (made of PFA) was extracted, nitric acid was added to the ultrapure water, and the concentration of nitric acid was adjusted to be 0.1%. After the adjustment, ICP mass spectrometry was performed on the ultrapure water, and mass-spectrometry values of metal ions, specifically, Al, Na, Cr, Cu, Ni, Zn and Ca were obtained (in units of μg/cm³). The results are summarized in the table shown in FIG. 7. Furthermore, the results shown in the table of FIG. 7 are plotted on bar graphs shown in FIGS. 8 and 9. In FIG. 8, the horizontal axis indicates the sample name, and the vertical axis indicates the ion concentration. In FIG. 9, the horizontal axis indicates the metal name, and the vertical axis indicates the ion concentration.

In FIG. 8, the first four items from the left on the horizontal axis are resin materials, the following four items are ceramic materials, and the last two items are a metal material and the metal material coated with fluorocarbon resin. Comparison of the resin materials (the first four items from the left) shows that the PEEK material (polyetheretherketone) produces lower ion concentrations than the other materials for all of the seven ions. Comparison of the PEEK material with the ceramic materials (the following four items) shows that the PEEK material produces lower ion concentrations than the ceramic materials, although elution of Ca ions is recognized.

Then, using the system (spray apparatus 80) according to the fifth embodiment described above with reference to FIG. 6, contamination (contamination) by metals was measured (the pump used incorporated a packing). As the cylinder, the pressure pump 10 was used. The measurement was performed on the order of ng/cm³.

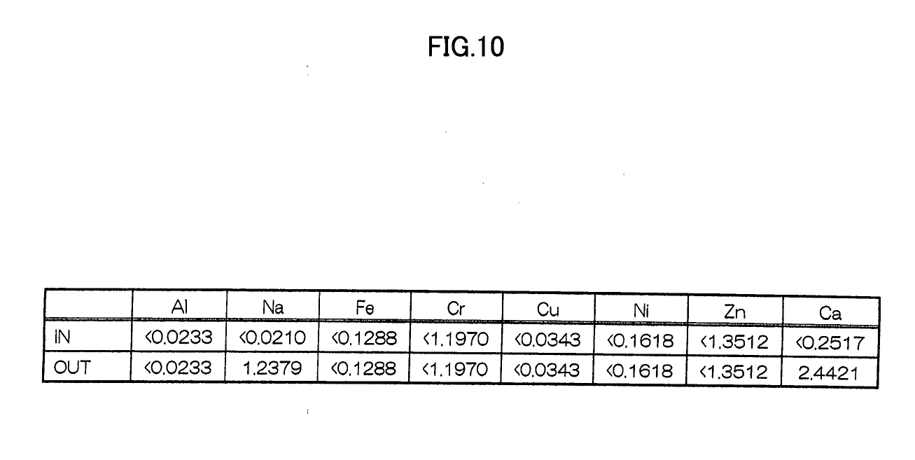

Pure water was supplied to the system via a straight path and sprayed from the nozzle part. The sprayed pure water was received in a vessel, and the pure water was measured by ICP-MASS. The measurement results are shown in the table in FIG. 10. “IN” in the table represents the amount of the metal ion contained in the pure water on the input side of the system, and “OUT” represents the amount of the metal ion contained in the pure water on the output side of the system.

The levels of all the metal ions are lower than 10 ng/cm3. Thus, the effectiveness of the present invention is demonstrated.

What is claimed is:

1. A liquid feed pump having a cylinder having a substantially cylindrical shape and
a piston fitted into the cylinder, and the liquid feed pressure is equal to or higher than 1 MPa and equal to or lower than 50 MPa,
wherein substantially the whole surface of a liquid contacting part of the liquid feed pump is made of a resin material or a ceramic material.

2. The liquid feed pump according to claim 1, wherein the clearance between the cylinder and the piston falls within a range of 1 to 20 μm over substantially the whole inner surface of the cylinder and the whole outer surface of the piston.

3. The liquid feed pump according to claim 1, wherein the amount of liquid leakage from the clearance between the cylinder and the piston is equal to or less than 2 L/minute.

4. The liquid feed pump according to claim 2, wherein the amount of liquid leakage from the clearance between the cylinder and the piston is equal to or less than 2 L/minute.

5. The liquid feed pump according to claim 1, wherein the resin material is polyetheretherketone.

6. The liquid feed pump according to claim 2, wherein the resin material is polyetheretherketone.

7. The liquid feed pump according to claim 3, wherein the resin material is polyetheretherketone.

8. The liquid feed pump according to claim 4, wherein the resin material is polyetheretherketone.

9. The liquid feed pump according to claim 1, wherein the ceramic material is zirconia.

10. The liquid feed pump according to claim 2, wherein the ceramic material is zirconia.

11. The liquid feed pump according to claim 3, wherein the ceramic material is zirconia.

12. The liquid feed pump according to claim 5, wherein the ceramic material is zirconia.

13. The liquid feed pump according to claim 1, wherein the amount of contamination of a liquid being fed by a metal ion is lower than 10 ng/cm³ in terms of ICP mass spectrometry value.

14. A filter housing that houses a filter element and is used under a liquid pressure equal to or higher than 1 MPa and equal to or lower than 50 MPa,
wherein substantially the w hole surface of a liquid contacting part of the filter housing is made of a resin material or a ceramic material.

15. The filter housing according to claim 14, wherein the resin material is polyetheretherketone.

16. The filter housing according to claim 14, wherein the ceramic material is zirconia.

17. A spray nozzle that is used under a liquid pressure equal to or higher than 1 MPa and equal to or lower than 50 MPa,
wherein substantially the whole surface of a liquid contacting part of the spray nozzle is made of a resin material or a ceramic material.

18. The spray nozzle according to claim 17, wherein the resin material is polyetheretherketone.

19. The spray nozzle according to claim 17, wherein the ceramic material is zirconia.

20. A valve that is used under a liquid pressure equal to or higher than 1 MPa and equal to or lower than 50 MPa,
wherein substantially the whole surface of a liquid contacting part of the valve is made of a resin material or a ceramic material.

21. The valve according to claim 20, wherein the resin material is polyetheretherketone.

22. The valve according to claim 20, wherein the ceramic material is zirconia.

23. A spray apparatus comprising:
a liquid feed pump;
a filter unit including a filter housing;
a valve;
a spray nozzle; and
a piping member that interconnects the liquid feed pump, the filter unit, the valve and the spray nozzle,
wherein the liquid feed pressure is equal to or higher than 1 MPa and equal to or lower than 50 MPa, and
substantially the whole surface of a liquid contacting part of the spray apparatus is made of a resin material or a ceramic material.

24. The spray apparatus according to claim 23, wherein the resin material is polyetheretherketone.

25. The spray apparatus according to claim 23, wherein the ceramic material is zirconia.

26. The spray apparatus according to claim 23, wherein the amount of contamination of a liquid being fed by a metal ion is lower than 10 ng/cm³ in terms of ICP mass spectrometry value.

27. The spray apparatus according to claim 24, wherein the amount of contamination of a liquid being fed by a metal ion is lower than 10 ng/cm³ in terms of ICP mass spectrometry value.

28. The spray apparatus according to claim 25, wherein the amount of contamination of a liquid being fed by a metal ion is lower than 10 ng/cm³ in terms of ICP mass spectrometry value.
